(19) United States
(12) Patent Application Publication
(10) Pub. No.: US 2010/0162644 A1
(43) Pub. Date: Jul. 1, 2010

(54) SILL CORNER WITH PATHWAY

(75) Inventors: Kevin A. Campbell, Klamath Falls, OR (US); John D. Stackpole, Klamath Falls, OR (US); Kenneth M. Hart, Klamath Falls, OR (US); Kenneth J. Christensen, Klamath Falls, OR (US)

Correspondence Address: JELD-WEN, Inc. - Stoel Rives LLP, 900 SW Fifth Avenue, Suite 2600, Portland, OR, 97204-1268, US

(73) Assignee: JELD-WEN, INC., Klamath Falls, OR (US)

(21) Appl. No.: 12/345,358

(22) Filed: Dec. 29, 2008

(51) Int. Cl. E06B 7/16; E06B 1/16; E04B 1/66; E04G 21/14

(52) U.S. Cl. 52/209; 52/656.2; 52/741.4; 52/745.19

(57) ABSTRACT

A sill corner key for use in a sill assembly configured to be supported on a base surface, the sill assembly including a lineal base member and a vertical jamb. The sill corner key includes a vertical component having a top surface, a bottom surface, and an inner wall extending between the top surface and the bottom surface, the inner wall defining a sealant pathway formed therein. The inner wall is configured to slidably receive a portion of the lineal base member and the sealant pathway is configured to direct a fluid sealant to flow along the portion of the lineal base member within the inner wall.

### FIELD OF THE INVENTION

The present invention relates generally to sills for windows and doors. More particularly, the present invention relates to a sill including a sill corner with a pathway configured to receive sealant after assembly of the sill.

### BACKGROUND

It is not uncommon for typical window and door sill assemblies to suffer from air and water leakage intrusion due, in part, to their construction. A typical sill assembly will include a horizontal sill member and a pair of vertical members, or jambs, at each end of the horizontal sill member. A joint between the horizontal sill member and a corresponding vertical jamb is formed by abutting the ends of the two members at a corner. The vertical jamb can abut the top surface of the horizontal sill member, the horizontal sill member can abut a side surface of the vertical jamb, or the horizontal and vertical members can be joined at a mitered corner. For each of the noted methods, a joint exists between the two members at a corner that is low on the sill assembly and therefore susceptible to being exposed to the elements, such as water.

Gaskets and sealants have been applied to joined corners in a variety of methods and configurations in an attempt to seal the joints and prevent water from leaking into the finished sill assembly. Application of these wet sealants and gaskets typically occurs under varying circumstances from job to job, and therefore, their effectiveness is often dependent upon the skill of the installer. Sealants, such as silicone-based compounds or urethane-based compounds, are ordinarily manually applied, subjecting the process to human error. There is a risk of applying insufficient sealant or misapplying the sealant. Gaskets are subject to similar problems, in that they are ordinarily manually applied. For example, gaskets may be ineffectively adhered to the corresponding structure or misaligned, leading to the gasket either separating from the sill assembly or simply functioning in an inefficient manner.

As such, it would be advantageous to have a sill assembly in which joints in the lower-most corners of the sill assembly can be sealed with minimal effort and skill on the part of the individual installer. As well, it would be desirable for a sill assembly to be constructed so that any joints in the vicinity of the lower-most corners do not provide a straight path for water to pass through the sill. As well, it would be desirable to positively join, such as by fasteners, a friction fit, etc., various components of the sill assembly.

### SUMMARY OF THE INVENTION

One embodiment of the present invention provides a sill corner key for use in a sill assembly configured to be supported on a base surface, the sill assembly comprising a lineal base member and a vertical jamb. The sill corner key comprises a vertical component comprising a top surface, a bottom surface, and an inner wall extending between the top surface and the bottom surface, the inner wall defines a sealant pathway formed therein. The inner wall is configured to slidably receive a portion of the lineal base member and the sealant pathway is configured to direct a fluid sealant to flow along the portion of the lineal base member within the inner wall.

Another embodiment of the present invention provides a sill assembly configured to be supported on a base surface. The sill assembly comprises a sill corner key comprising a top surface, a bottom surface, and an inner wall extending therebetween, the inner wall defining a receiving groove and a sealant pathway. The sill assembly also comprises a lineal base member comprising an abutment edge. The receiving groove is configured to slidably receive the abutment edge of the lineal base member and the sealant pathway is configured to direct a fluid sealant to flow along the abutment edge in the sealant pathway.

Yet another embodiment of the present invention provides a method of making a sill corner key for use in a sill assembly configured to be supported on a base surface, the sill assembly comprising a lineal base member and a vertical jamb. The method comprises providing a vertical component comprising a top surface, a bottom surface, and an inner wall extending between the top surface and the bottom surface, and forming a sealant pathway in the inner wall of the vertical component. The inner wall is configured to slidably receive a portion of the lineal base member and the sealant pathway is configured to direct a fluid sealant to flow along the portion of the lineal base member within the inner wall.

Further details on each of these aspects of the present invention are set forth in the following description, figures and claims. It is to be understood that the invention is not limited in its application to the details set forth in the following description, figures and claims, but is capable of other embodiments and of being practiced or carried out in various ways.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of an embodiment of a sill corner assembly in accordance with the present invention;

FIG. 2A is a perspective view of the embodiment of a sill corner key, as shown in FIG. 1, in accordance with the present invention;

FIG. 2B is a left-side view of the sill corner key as shown in FIG. 2A;

FIG. 2C is a top view of the sill corner key as shown in FIG. 2A;

FIG. 2D is a bottom view of the sill corner key as shown in FIG. 2A;

FIG. 2E is a right-side view of the sill corner key as shown in FIG. 2A;

FIG. 2F is a rear view of the sill corner key as shown in FIG. 2A;

FIG. 2G is a cross-sectional view of the sill corner key, as shown in FIG. 2A, taken along line 2G-2G of FIG. 2B;

FIG. 2H is a cross-sectional view of the sill corner key, as shown in FIG. 2A, taken along line 2H-2H of FIG. 2B;

FIG. 3A is a perspective view of the embodiment of a lineal base member, as shown in FIG. 1, in accordance with the present invention;

FIG. 3B is a top view of the lineal base member as shown in FIG. 3A;

FIG. 3C is a left-side view of the lineal base member as shown in FIG. 3A;

FIG. 3D is a front view of the lineal base member as shown in FIG. 3A;

FIG. 3E is a cross-sectional view of the lineal base member, as shown in FIG. 3A, taken along line 3E-3E of FIG. 3D;

FIGS. 4A and 4B are top cross-sectional and bottom views, respectively, of the embodiment of a side jamb, as shown in FIG. 1, in accordance with the present invention;

FIG. 5A is a top cross-sectional view of the embodiment of vertical cladding, as shown in FIG. 1, in accordance with the present invention;

FIG. 5B is a right-side view of the vertical cladding as shown in FIG. 5A;

FIG. 5C is a left-side view of the vertical cladding as shown in FIG. 5A;

FIG. 6A is a left-side view of the sill corner key, as shown in FIG. 2A, and the lineal base member, as shown in FIG. 3A, after they have been slidably joined to each other;

FIG. 6B is a top view of the joined sill corner key and lineal base member as shown in FIG. 6A; and

FIG. 6C is a right-side view of the joined sill corner key and lineal base member as shown in FIG. 6A.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used in another embodiment to yield a still further embodiment. Thus, it is intended that the present invention covers such modifications and variations as come within the scope of the appended claims and their equivalents.

Referring now to the Figures, a sill corner assembly 100 in accordance with the present invention is shown. In the preferred embodiment shown, sill corner assembly 100 is configured for use with a sliding-style dual panel door, one or both of which may be slid relative to the sill. Sill corner assembly 100 includes a sill corner key 110, a lineal base member 200, a side jamb 250, a vertical cladding 270. Lineal base member 200 is received adjacent the inner surface of sill corner key 110, thereby forming the horizontal component of sill corner assembly 100, and side jamb 250 is received adjacent the top surface of sill corner key 110, thereby forming the vertical component of sill corner assembly 100. Vertical cladding 270 is slidably received on side jamb 250 and sill corner key 110 to complete sill corner assembly 100, as discussed in greater detail below.

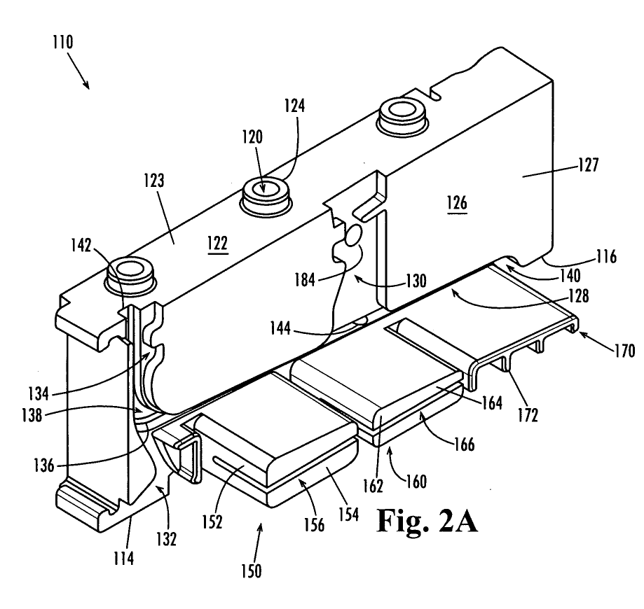

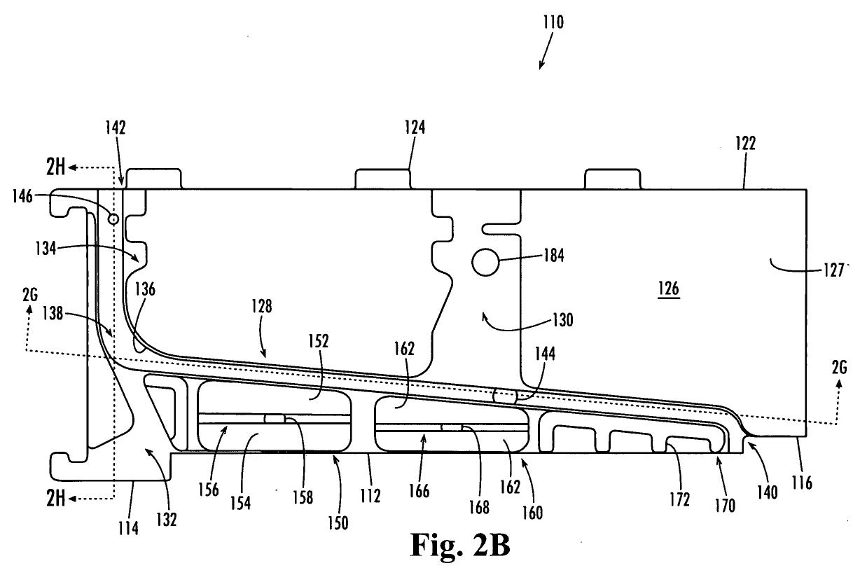

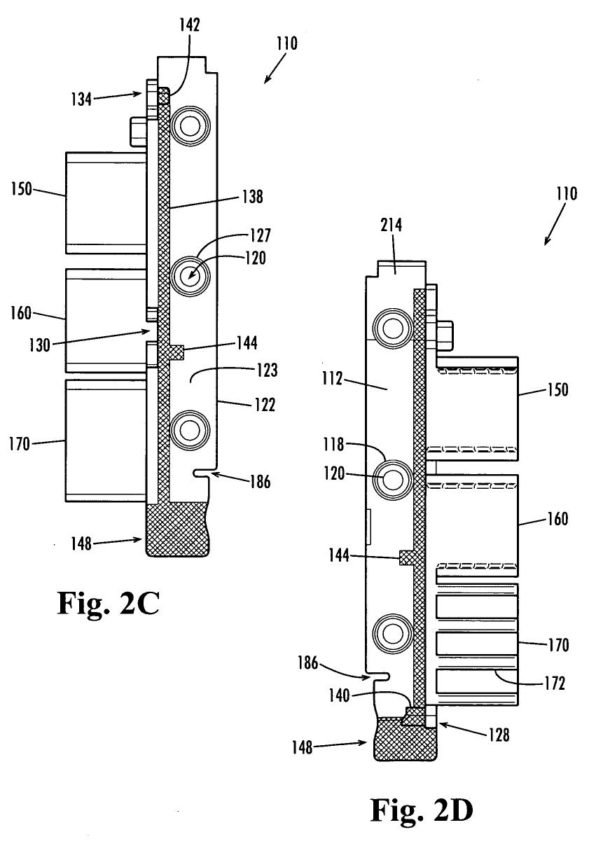

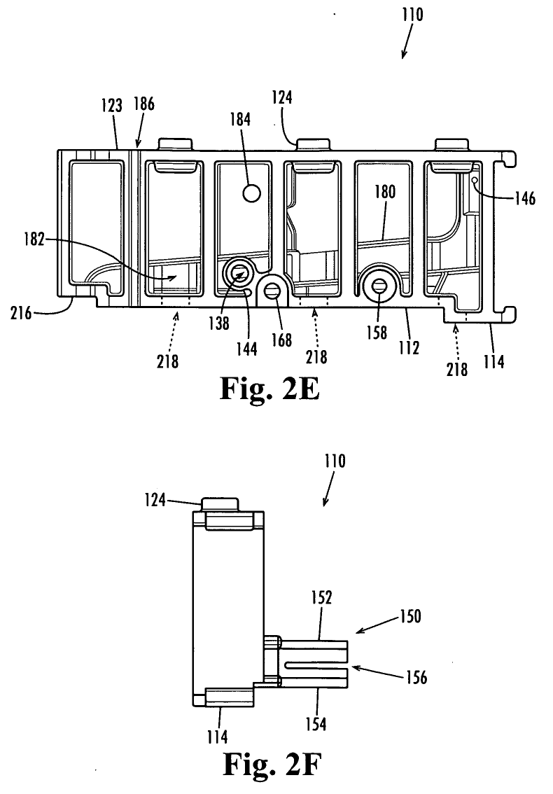

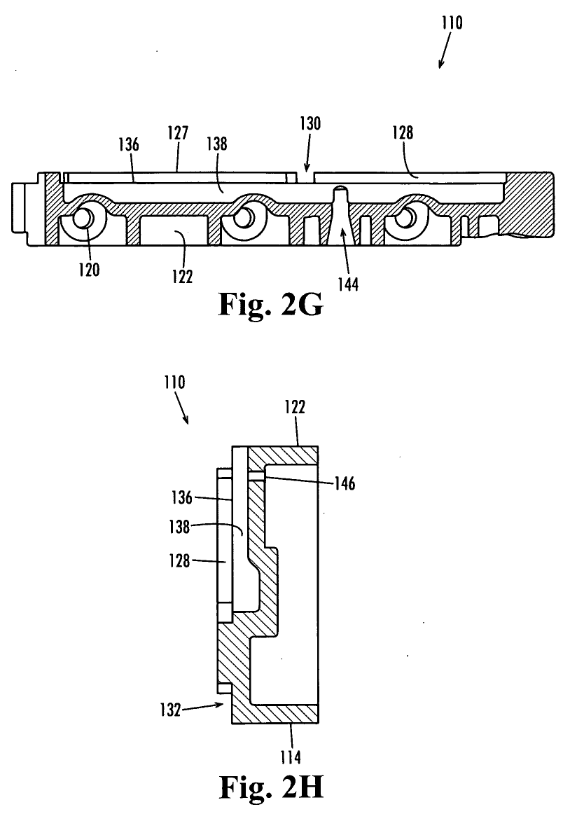

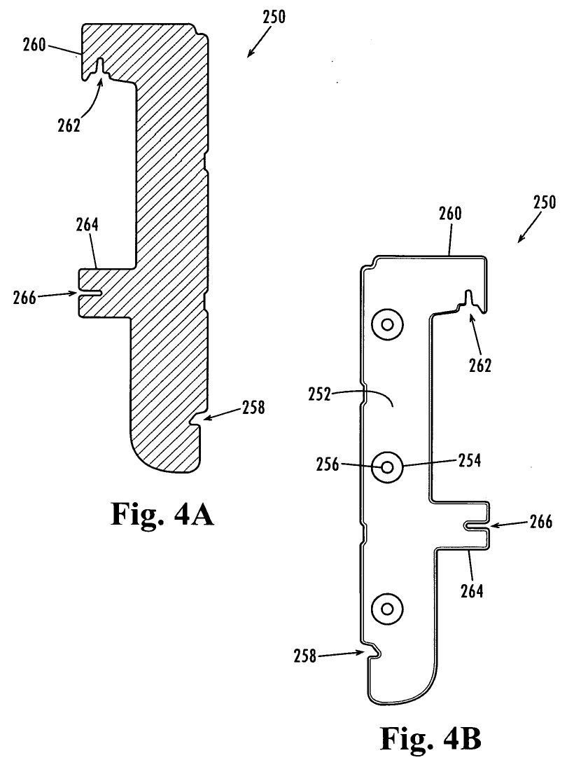

Referring now to FIGS. 2A through 2H, sill corner key 110 in accordance with the present invention is shown. Sill corner key 110 includes a recessed bottom surface 112 extending between a rear base 114 and a front shelf 116. As best seen in FIG. 2D, bottom surface 112 defines a plurality of access apertures 118 therethrough. Access apertures 118 are configured to allow access to a corresponding number of fastener apertures 120 that are defined in a top wall 122 of sill corner key 110. Top wall 122 of sill corner key 110 is parallel to bottom wall 112 and extends the full length of sill corner key 110. Fastener apertures 120 are configured to receive fasteners (not shown), such as threaded screws, therein so that side jamb 250 (FIGS. 4A and 4B) can be secured to top wall 122 of sill corner key 110. Each fastener aperture 120 is circumscribed by a post 124 that extends upwardly from top surface 123 of top wall 122, thereby facilitating the proper positioning of side jamb 250 relative to sill corner key 110 and lending rigidity to the corresponding fastener apertures 120. In the embodiment shown, sill corner key 110 is formed as a unitary element by injection molding such that no seams or joints are present. However, various other manufacturing methods can be used.

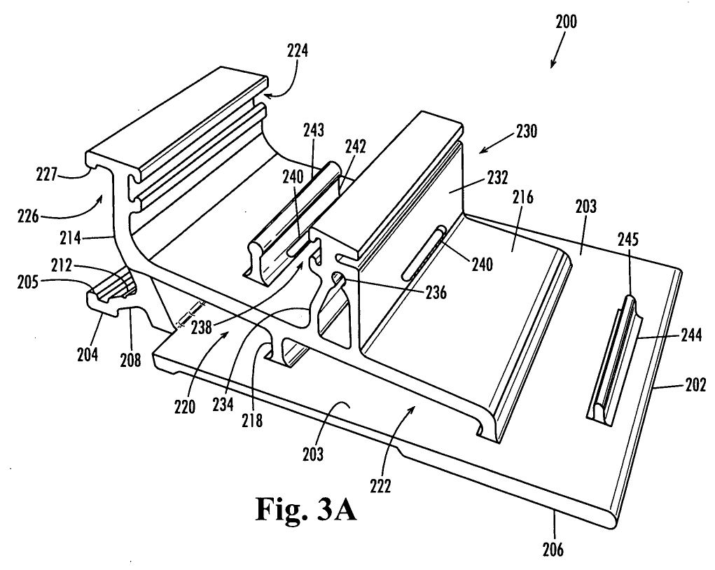

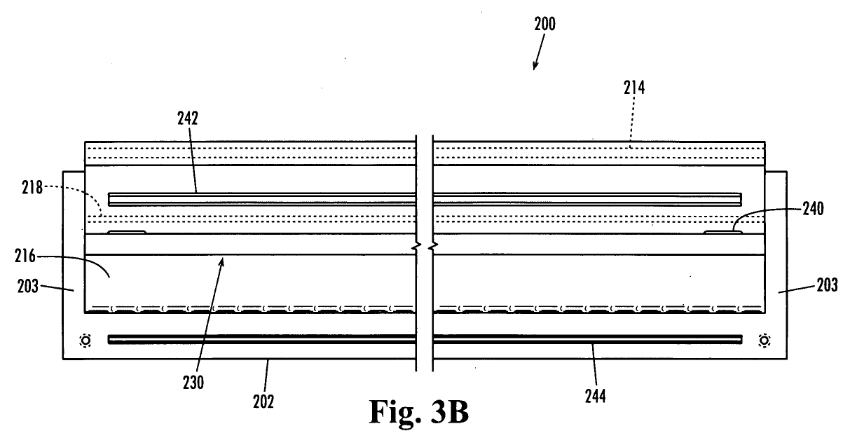

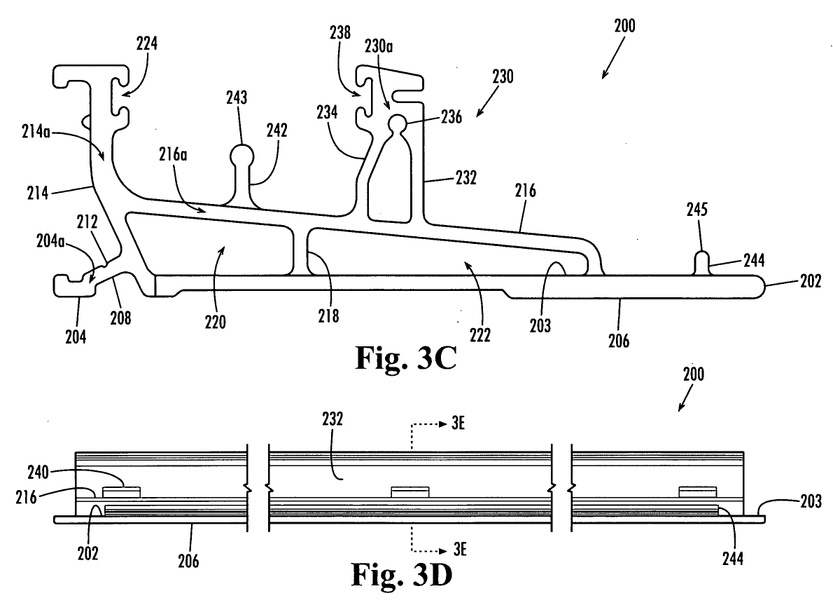

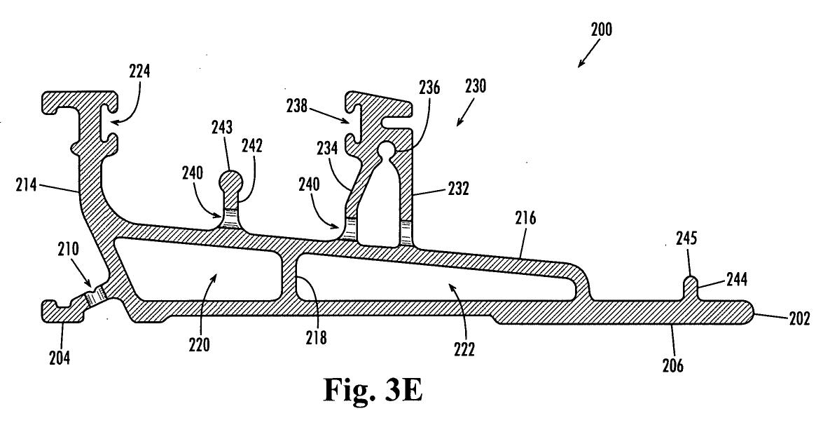

Sill corner key 110 includes an inner wall 126 that extends from the front to the rear of sill corner key 110 and is perpendicular to both bottom wall 112 and top wall 122. A receiving groove 128 extends inwardly into inner wall 126 from its inner surface 127 and is configured to slidably receive abutting portions of lineal base member 200 (FIGS. 3A through 3E), as is discussed in greater detail below. Receiving groove 128 includes an upstand recess 130, a base recess 132, a rear wall recess 134 and a pair of internal ridges 136. Each of upstand recess 130, base recess 132 and rear wall recess 134 are configured to slidably receive a corresponding abutting end portion of lineal base member 200. In so doing, upstand recess 130, base recess 132 and rear wall recess 134 function to limit the extent to which the abutting portions of lineal base member 200 can be inserted into receiving groove 128. Additionally, ridges 136 also limit the extent to which lineal base member 200 can be inserted into receiving groove 128 because the distance separating ridges 136 is selected such that it is less than the width of the corresponding abutting portion of lineal base member 200 positioned in receiving groove 128.

Additionally, sill corner key 110 includes a sealant pathway 138 that extends along the length of receiving groove 128 from the front to the rear of sill corner key 110. Sealant pathway 138 is disposed inwardly of receiving groove 128 relative to inner wall 126 of sill corner key 110. Sealant pathway 138 extends from a first aperture 140 that is disposed at the front of sill corner key 110 adjacent front shelf 116 rearwardly to a second aperture 142 that is defined by top wall 122 of sill corner key 110. Additionally, sealant pathway 138 includes an injection port 144 and an expulsion port 146. As best seen in FIG. 2E, injection port 144 extends inwardly into sealant pathway 138 from the outer surface of sill corner key 110. Injection port 144 is adapted to accept or receive sealant injected into sill corner key 110. Injection port 144 is generally circular in shape and is circumscribed by sufficient material to provide the injection port 144 with sufficient rigidity to remain dimensionally stable when injecting sealant into sill corner key 110. Expulsion port 146 is also in communication with sealant pathway 138. Expulsion port 146 extends into sealant pathway 138 from the outer surface of sill corner key 110 and is disposed proximate top wall 122 of sill corner key 110 so it is adjacent the upper portion of sealant pathway 138. Expulsion port 146 is adapted to permit sealant, as well as a fluid or gas, to escape or vent from sealant pathway 138. Alternatively to the embodiment shown, other suitable arrangements and configurations for injection port 144 and expulsion port 146 can be used in alternate embodiments.

Referring now to FIGS. 2C and 2D, the cross-hatching in these Figures illustrates sealant pathway 138. As previously noted, first aperture 140 of sealant pathway 138 is adjacent front shelf 116 of sill corner key 110. As such, and as discussed in greater detail below, this puts sealant pathway 138 in communication with a void 148 that is enclosed by portions of sill corner key 110, lineal base member 200 and vertical cladding 270. Therefore, as sealant is injected into sealant pathway 138 by way of injection port 144, sealant will eventually fill void 148. Sealant pathway 138 runs rearwardly from first aperture 140 and terminates at second aperture 142. Note, when side jamb 250 (FIGS. 4A and 4B) is secured to top wall 122 of sill corner key 110, bottom surface 252 of side jamb 250 seals off sealant pathway 138 at second aperture 142. As such, in the preferred embodiment shown, expulsion port 146 is formed in the vicinity of second aperture 142 to allow venting to occur near the upper portion of sealant pathway 138.

As best seen in FIGS. 2A and 2B, sill corner key 110 includes a first wedge 150, a second wedge 160 and a projection 170 depending transversely from inner surface 127 of inner wall 126. First wedge 150 includes a top portion 152, a bottom portion 154, a planar gap 156 disposed therebetween, a fastener aperture 158, and is arranged and configured to be slidably received within a corresponding portion of lineal base member 200 (FIGS. 3A through 3E). As also seen in FIG. 2E, fastener aperture 158 extends inwardly from the outside of sill corner key 110 into planar gap 156. In the preferred embodiment shown, the diameter of fastener aperture 158 is greater than the width of planar gap 156 such that a fastener having a greater diameter than the width of planar gap 156 can be urged between top portion 152 and bottom portion 154. As such, as a fastener, such as a screw, is driven into planar gap 156, top portion 152 and bottom portion 154 are urged outwardly away from each other. In this manner, first wedge 150 engages a corresponding portion of lineal base member 200 in a friction fit, as discussed in greater detail below.

Similarly, second wedge 160 includes a top portion 162, a bottom portion 164, a planar gap 166 disposed therebetween, a fastener aperture 168, and is arranged and configured to be slidably received by a corresponding portion of lineal base member 200. Projection 170 includes a plurality of downwardly depending support ribs 172 and is also configured to be slidably received by lineal base member 200.

Referring now to FIG. 2E, the outside surface of inner wall 126 includes a raised channel housing 180, a fastener aperture 184 and a vertical slot 186. Raised channel housing 180 runs the length of sealant pathway 138 from first aperture 140 to second aperture 142 and lends structural integrity to sealant pathway 138. By using raised channel housing 180 to form sealant pathway 138, the amount of material required to form sill corner key 110 can be reduced. However, alternate embodiments are possible wherein the overall thickness of inner wall 126 is the same as that of top wall 122 and bottom wall 112 of sill corner key 110. Fastener aperture 184 is arranged and configured such that a fastener, such as a threaded screw, can be passed therethrough and engage a corresponding portion of lineal base member 200 to help secure the two parts together. Vertical slot 186 is configured to receive a corresponding portion of vertical cladding 270, as discussed in greater detail below.

Referring now to FIGS. 3A through 3C, lineal base member 200, in accordance with the present invention, is shown. Lineal base member 200 includes a planar surface 202 extending between a rear base 204 and a front base 206. Rear base 204 includes an angled wall 208 and defines a plurality of angled apertures 210 (FIG. 3E) that are configured to receive fasteners so that lineal base member 200 can be secured to a base surface. Additionally, angled wall 208 includes a longitudinal groove 212 that extends along its length and is centered on fastener apertures 210. Groove 212 facilitates forming additional fastener apertures 210 by helping to properly position them on angled wall 208.

A rear wall 214 extends upwardly from rear base 204 and defines a weatherstrip groove 224 that extends along the length of rear wall 214 adjacent its upper inside edge. A channel 226 is formed by a downwardly depending groove 227 that extends outwardly from the top edge of rear wall 214 and an upwardly depending groove 205 that extends along the length of rear base 204. Channel 226 is configured to receive a decorative panel (not shown) to improve the appearance of the sill corner assembly after installation. A planar top surface 216 extends downwardly from rear wall 214 toward front base 206 such that any liquids received on top surface 216 drain away from rear wall 214 toward the front base 206 of lineal base member 200. Preferably, top surface 216 extends downwardly at an angle of from about three degrees (3°) to about five degrees (5°), most preferably about four degrees (4°).

An upstand 230 depends upwardly from top surface 216 and is substantially parallel to rear wall 214. Upstand 230 includes a front wall 232 and a rear wall 234 that meet along their upper edges thereby forming a void. A fastener groove 236 is defined where the top portions of front wall 232 and rear wall 234 meet and is positioned such that fastener groove 236 is in alignment with fastener aperture 184 (FIG. 2E) of sill corner key 110 when the two members are assembled. A weatherstrip groove 238 extends along the length of upstand 230 adjacent the upper edge of rear wall 234. As such, weatherstrip groove 238 of upstand 230 and weatherstrip groove 224 of rear wall 214 are substantially parallel to each other and oppose each other. Additionally, weep holes 240 are formed in both front wall 232 and rear wall 234 of upstand 230 to allow for the drainage of any water that is received on top surface 216 between rear wall 214 and upstand 230.

As noted above, lineal base member 200 includes various portions that are slidably received in receiving groove 128 of sill corner key 110 during assembly. More specifically, as best seen in FIG. 3C, lineal base member 200 includes an abutting edge 204a of rear base 204 that is received in base recess 132, an abutting edge 214a of rear wall 214 that is received in rear wall recess 134, an abutting edge 216a of top surface 216 that is received along the length of receiving groove 128, and an abutting edge 230a of upstand 230 that is received in upstand recess 130. Additionally, planar surface 202 of lineal base member 200 extends outwardly beyond the abutting edges at both ends of lineal base member 200, thereby forming a platform 203 at each end of lineal base member 200. Each platform 203 is configured to be slidably received adjacent a recessed bottom wall 112 of a corresponding sill corner key 110 during assembly of sill corner assembly 100, as discussed in greater detail below.

A door panel track 242 extends upwardly from the portion of top surface 216 that is between rear wall 214 and upstand 230. Door panel track 242 extends for substantially the length of lineal base member 200 and includes a rounded top edge that is configured to receive rollers, sliders, etc., that are disposed on a bottom frame member of a slidable door panel (not shown) that is received within the groove defined by rear wall 214, top surface 216 and upstand 230. As such, door panel track 242 is arranged and configured to facilitate sliding movement of the door panel within the groove along the length of lineal base member 200. Weatherstrip grooves 224 and 238 are configured to receive weatherstrip material (not shown) that depends inwardly into the groove, thereby making contact with the bottom frame member of the door panel and minimizing the amount of water that enters the door panel groove. For any water that may enter the groove, weep holes 240 are provided in door panel track 242 in addition to weep holes 240 in front wall 232 and rear wall 234 of upstand 230.

A screen track 244 extends upwardly from planar surface 202 adjacent the front of lineal base member 200. Similarly to door panel track 242, screen track 244 extends for substantially the length of lineal base member 200 and includes a rounded top edge 245 that is configured to slidably receive rollers, sliders, etc., that are disposed on a bottom frame member of a screen panel (not shown). As such, screen track 244 facilitates the sliding motion of a screen panel along the length of lineal base member 200.

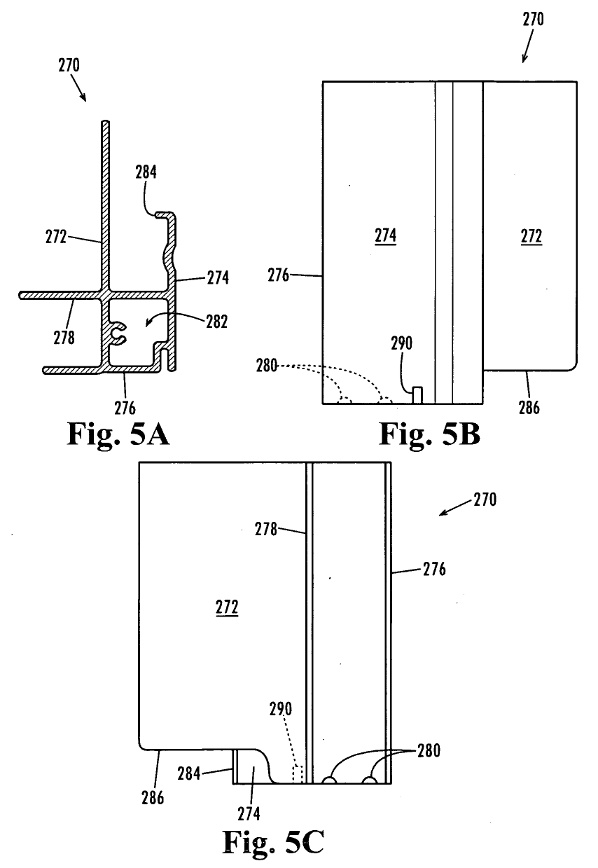

Referring now to FIGS. 4A and 4B, side jamb 250, in accordance with the present invention, is shown. Bottom surface 252 of side jamb 250 includes a plurality of post recesses 254, each being formed about a respective fastener aperture 256. Post recesses 254 are each configured to receive one of the plurality of posts 124 disposed on top wall 122 of sill corner key 110. Apertures 256 are configured to receive fasteners such that side jamb 250 can be securely attached to top wall 122 of sill corner key 110. Side jamb 250 includes a vertical slot 258 that corresponds to vertical slot 186 of sill corner key 110, both vertical slots being configured to slidably receive a portion of vertical cladding 270 (FIGS. 5A through 5C). Additionally, side jamb 250 includes a first inwardly depending projection 260 and a second inwardly depending projection 264. First projection 260 includes a weatherstrip slot 262 and is disposed on side jamb 250 such that when side jamb 250 is secured to sill corner key 110, first projection 260 is disposed adjacent the top surface of rear wall 214. Similarly, second projection 264 includes a weatherstrip slot 266 and is disposed on side jamb 250 such that second projection 264 is disposed adjacent the top surface of upstand 230.

Referring now to FIGS. 5A through 5C, a portion of vertical structural cladding 270, in accordance with the present invention, is shown. Vertical cladding 270 includes an inner wall 272 and an outer wall 274 that are substantially parallel to each other, and a front wall 276 and a middle wall 278 that are substantially parallel to each other, as well as being substantially transverse to both inner wall 272 and outer wall 274. A pair of drainage holes 280 is defined by the bottom edge of inner wall 272 to allow for drainage from a void 282 that is defined by portions of inner wall 272, outer wall 274, front wall 276 and middle wall 278. As best seen in FIG. 5A, an inwardly depending fin 284 is disposed along the rear edge of outer wall 274. Fin 284 is configured to be slidably received by vertical slots 186 and 258 of sill corner key 110 and side jamb 250, respectively.

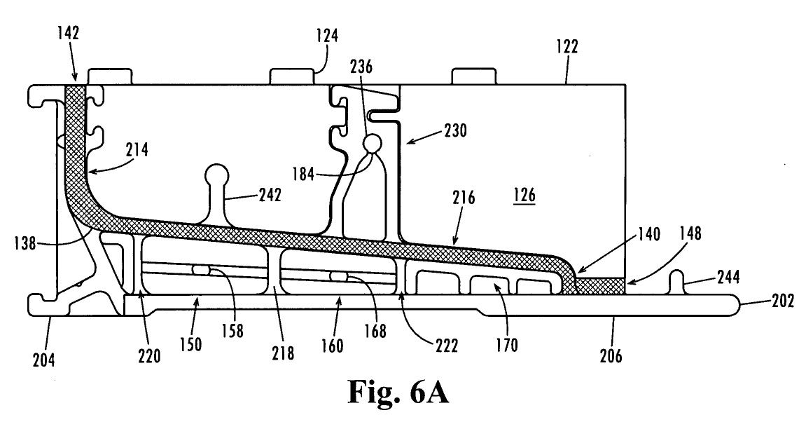

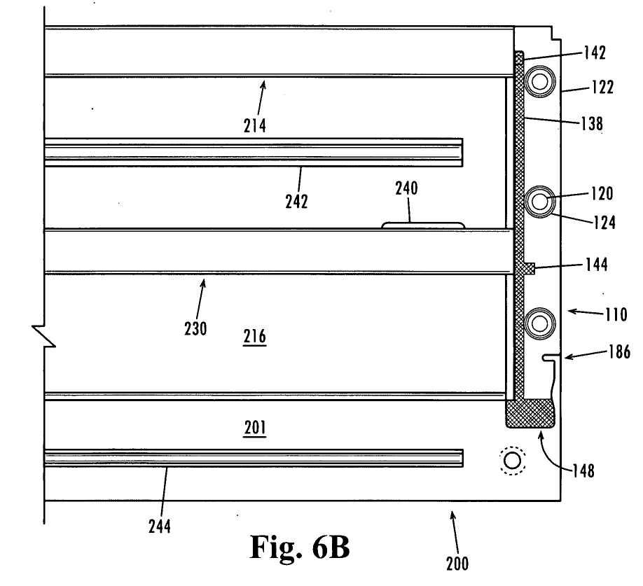

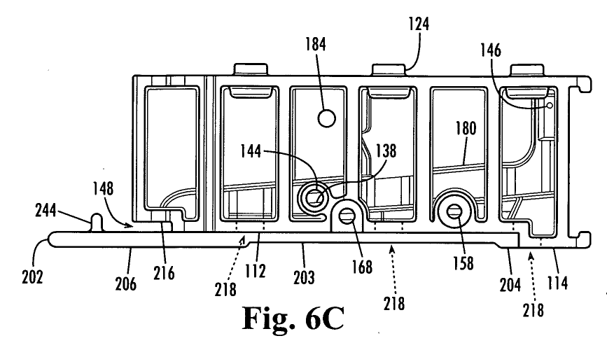

Inner wall 272 of vertical cladding 270 includes a contoured bottom edge portion 286 that is configured to abut top surface 216 of lineal base member 200, whereas the other bottom edges of vertical cladding 270 abut planar surface 202. After assembly of sill corner assembly 100, portions of inner wall 272, outer wall 274, middle wall 278, front shelf 116 of sill corner key 110, and platform 203 of lineal base member 200 define a void 148 (FIG. 6A) that is configured to receive sealant, as discussed in greater detail below. An expulsion port 290 is formed in the bottom edge of outer wall 274 and is in communication with void 148.

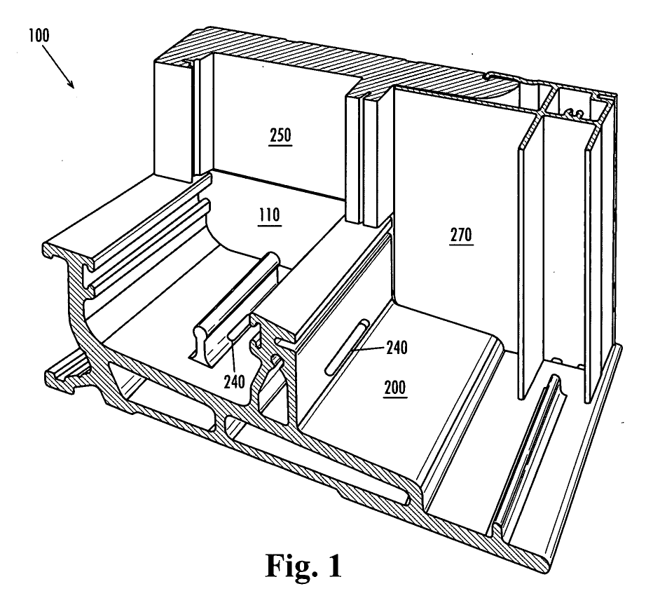

To assemble sill corner assembly 100, as shown in FIG. 1, sill corner key 110, as shown in FIGS. 2A through 2H, and side jamb 250, as shown in FIGS. 4A and 4B, are first assembled. As previously noted, posts 124 on top wall 122 of sill corner key 110 are slidably received in post recesses 254 formed in bottom surface 252 of side jamb 250. Next, threaded fasteners are passed from the underside of sill corner key 110 through apertures 120 and 256 (FIG. 4B) in order to secure side jamb 250 to sill corner key 110. Access apertures 118, as best seen in FIG. 2D, defined in bottom wall 112 of sill corner key 110 allow both the passage of threaded fasteners through bottom wall 112 as well as access thereto with a tool for tightening. A joint is formed between top surface 123 of sill corner key 110 and bottom surface 252 of side jamb 250. In the preferred embodiment shown, the joint is disposed about 1.44 inches above the base surface (not shown) to which the sill assembly is secured. In the preferred embodiments shown, this height is determined based on achieving a differential pressure of at least 50 psi between the interior and exterior of the structure in which the sill assembly and associated sliding door are installed, without a column of water being able to reach the height of the joint.

Next, as shown in FIGS. 6A through 6C, sill corner key 110 and lineal base member 200, as shown in FIGS. 3A through 3E, are assembled. Note, to facilitate the discussion of assembling sill corner key 110 and lineal base member 200, side jamb 250, that has previously been secured to sill corner key 110, is omitted. To assemble sill corner key 110 and lineal base member 200, first wedge 150 of sill corner key 110 is inserted in first void 220 of lineal base member 200, and second wedge 160 and projection 170 are inserted in second void 222. First wedge 150, second wedge 160 and projection 170 are urged inwardly into first and second voids 220 and 222 until the abutting edges of lineal base member 200 are positioned in receiving groove 128 of sill corner key 110. More specifically, insertion of lineal base member 200 into receiving groove 128 ceases when abutting edge 204a of rear base 204 is received in base recess 132, abutting edge 214a of rear wall 214 is received in rear wall recess 134, abutting edge 230a of upstand 230 is received in upstand recess 130, and abutting edge 216a of top surface 216 abuts opposed ridges 136 which are disposed along the length of receiving groove 128. Additionally, as best seen in FIG. 6C, as the abutting edges of lineal base member 200 are being inserted into receiving groove 128, platform 203 of lineal base member 200 is slidably received adjacent recess bottom wall 112 of sill corner key 110. As such, when assembled, the bottom surface of bottom wall 112 is adjacent the top surface of platform 203 and a void 148 is formed by the top surface of platform 203 and front shell 216 of sill corner key 110.

In the preferred embodiment shown, the edges defining receiving groove 128 are arranged and configured to exert a friction force on the corresponding portions of lineal base member 200 that are received therein. However, as best seen in FIG. 6C, to further secure sill corner key 110 and lineal base member 200 together, fasteners, such as screws, are threaded into fastener apertures 158 and 168 of first wedge 150 and second wedge 160, respectively. As the threaded fasteners are driven into the respective planar gaps 156 and 166, the top and bottom portions of the first and second wedges 150 and 160 are urged outwardly away from each other. As such, top portion 152 and bottom portion 154 of first wedge 150 frictionally engage the upper and lower surfaces that define first void 220, whereas top portion 162 and bottom portion 164 of second wedge 160 frictionally engage the upper and lower surfaces that define second void 222. Additionally, a threaded fastener is inserted through fastener aperture 184 to threadably engage fastener groove 236 that is disposed in the upper end of upstand 230.

Next, vertical cladding 270, as shown in FIGS. 5A through 5C, is slidably mounted on side jamb 250 and sill corner key 110. Fin 284 on outer wall 274 is positioned in vertical slot 258 of side jamb 250 and slid downwardly until fin 284 enters vertical slot 186 of sill corner key 110. Vertical cladding 270 is slid downwardly until contoured bottom edge portion 286 of inner wall 272 abuts top surface 216 of lineal base member 200 and the remaining lower edges of vertical cladding 270 abut planar surface 202. With vertical cladding 270 so positioned, a void 148 is defined between front shelf 116 of sill corner key 110, planar surface 202 of lineal base member 200, and the lower most portions of vertical cladding 270, as discussed above. Expulsion post 290 is in communication with void 148 to allow the venting of gasses and passage of sealant during the injection process.

After the assembly of sill corner assembly 100 is completed, sealant pathway 138 is ready to receive and communicate the sealant (not shown). Generally, the sealant is a silicone-based compound or a urethane-based compound. As the sealant is injected into sealant pathway 138 through injection port 144, the injected sealant is uniformly distributed along sealant pathway 138. As the sealant flows forwardly in sealant pathway 138 and fills void 148, air and gases vent through expulsion port 290. Eventually, some of the sealant escapes through expulsion port 290 as well. Similarly, as the sealant flows rearwardly toward top wall 122 of sill corner key 100, excess air and gases, and eventually sealant, escape through expulsion port 146. Typically, cured or hardened sealant in sealant pathway 138 prevents the egress of the sealant through either injection port 144 or expulsion ports 146 and 290. Alternately, sealant pathway 138 can be sealed or closed by other suitable means, such as, for example, mechanically attaching or adhering a cap or cover to injection port 144 and expulsion ports 146 and 290.

While one or more preferred embodiments of the invention are described above, it should be appreciated by those skilled in the art that various modifications and variations can be made in the present invention without departing from the scope and spirit thereof.

What is claimed:

1. A sill corner key for use in a sill assembly configured to be supported on a base surface, the sill assembly comprising a lineal base member and a vertical jamb, the sill corner key comprising:
a vertical component comprising a top surface, a bottom surface, and an inner wall extending between the top surface and the bottom surface, the inner wall defining a sealant pathway formed therein,
wherein the inner wall is configured to slidably receive a portion of the lineal base member and the sealant pathway is configured to direct a fluid sealant to flow along the portion of the lineal base member within the inner wall.

2. The sill corner key of claim 1, further comprising a receiving groove defined by the inner wall of the vertical component, the receiving groove being configured to slidably receive the portion of the lineal base member.

3. The sill corner key of claim 2, wherein an upper portion of the sealant pathway is defined by a pair of substantially parallel ridges, wherein the pair of ridges is configured to abut the portion of the lineal base member that is slidably received in the receiving groove.

4. The sill corner key of claim 2, wherein the receiving groove further comprises a pair of opposed sidewalls, wherein the pair of sidewalls exerts a friction force on the portion of the lineal base member received in the receiving groove.

5. The sill corner key of claim 2, wherein the top and bottom surfaces of the vertical component are separated by a height, the height being between about 1.00 and 3.00 inches, and the top surface being adapted to receive the vertical jamb.

6. The sill corner key of claim 2, wherein the sealant pathway further comprises an injection port that is in fluid communication with the sealant pathway.

7. The sill corner key of claim 6, wherein the injection port extends into the sealant pathway from an outside surface of the sill corner key.

8. A sill assembly configured to be supported on a base surface, the sill assembly comprising:
a sill corner key comprising a top surface, a bottom surface, and an inner wall extending therebetween, the inner wall defining a receiving groove and a sealant pathway; and
a lineal base member comprising an abutment edge,
wherein the receiving groove is configured to slidably receive the abutment edge of the lineal base member and the sealant pathway is configured to direct a fluid sealant to flow along the abutment edge in the sealant pathway.

9. The sill assembly of claim 8, wherein a pair of substantially parallel ridges is disposed between the sealant pathway and the receiving groove, the pair of ridges being configured to abut the abutment edge of the lineal base member when the abutment edge is inserted into the receiving groove.

10. The sill assembly of claim 8, wherein the receiving groove further comprised a pair of opposed sidewalls, wherein the sidewalls exert a friction force on the abutment edge of the lineal base member.

11. The sill assembly of claim 8, wherein the sealant pathway further comprises an injection port that is in fluid communication with the sealant pathway.

12. The sill assembly of claim 8, wherein the sill corner key further comprises a wedge extending outwardly from the inner wall that is adapted to be slidably received in the lineal base member, the wedge exerting a friction force on the lineal base member.

13. The sill assembly of claim 8, further comprising a vertical jamb, wherein the top surface of the sill corner key is adapted to receive the vertical jamb.

14. The sill assembly of claim 13, wherein the top surface of the sill corner key further comprises at least one post extending upwardly therefrom and the vertical jamb further comprises at least one recess, the at least one recess being adapted to slidably receive the at least one post.

15. A method of making a sill corner key for use in a sill assembly configured to be supported on a base surface, the sill assembly comprising a lineal base member and a vertical jamb, the method comprising:
providing a vertical component comprising a top surface, a bottom surface, and an inner wall extending between the top surface and the bottom surface; and
forming a sealant pathway in the inner wall of the vertical component,
wherein the inner wall is configured to slidably receive a portion of the lineal base member and the sealant pathway is configured to direct a fluid sealant to flow along the portion of the lineal base member within the inner wall.

16. The method of making a sill corner key of claim 15, further comprising forming a receiving groove in the inner surface of the vertical component, the receiving groove being configured to slidably receive the portion of the lineal base member.

17. The method of making a sill corner key of claim 16, further comprising forming a pair of substantially parallel ridges between the sealant pathway and the receiving groove, wherein the pair of ridges is configured to abut the portion of the lineal base member that is slidably received in the receiving groove.

18. The method of making a sill corner key of claim 16, further comprising forming an injection port that is in fluid communication with the sealant pathway.
